(19) United States
(12) Patent Application Publication
(10) Pub. No.: US 2015/0229432 A1
(43) Pub. Date: Aug. 13, 2015

(54) FULL-DUPLEX ETHERNET COMMUNICATIONS OVER COAXIAL LINKS USING TIME-DIVISION DUPLEXING

(71) Applicants: Stephen Shellhammer, San Diego, CA (US); Juan Montojo, San Jose, CA (US); Andrea Garavaglia, Nuremberg (DE); Christian Pietsch, Nuremberg (DE); Nicola Varanese, Nuremberg (DE); Honger Nie, Beijing (CN)

(72) Inventors: Stephen Shellhammer, San Diego, CA (US); Juan Montojo, San Jose, CA (US); Andrea Garavaglia, Nuremberg (DE); Christian Pietsch, Nuremberg (DE); Nicola Varanese, Nuremberg (DE); Honger Nie, Beijing (CN)

(21) Appl. No.: 14/391,664

(22) PCT Filed: May 9, 2012
(86) PCT No.: PCT/CN2012/075255

§ 371 Date: Apr. 27, 2015

(51) Int. Cl. H04J 14/02; H04L 27/26

(52) U.S. Cl. CPC H04J 14/0239; H04L 27/2601

(57) ABSTRACT

A coax line terminal coupled to a plurality of coax network units by a coax plant uses time-division duplexing to communicate with the coax network units. In the coax line terminal, a control signal is repeatedly asserted and de-asserted. When the control signal is de-asserted, data are transmitted from the coax line terminal to the plurality of coax network units on a specified frequency band. When the control signal is asserted, transmission of the data ceases and data are received from respective coax network units on the specified frequency band.

### TECHNICAL FIELD

The present embodiments relate generally to communication systems, and specifically to communications over coaxial cable plants.

### BACKGROUND OF RELATED ART

The Ethernet Passive Optical Networks (EPON) protocol may be extended over coaxial (coax) links in a cable plant. The EPON protocol as implemented over coax links is called EPOC. Implementing an EPOC network or similar network over a coax cable plant presents significant challenges. For example, cable operators traditionally use frequency-division duplexing (FDD), in which separate frequency bands are used for upstream and downstream transmissions. FDD implementations, however, suffer from a lack of available spectrum and may have difficulty providing adequate upstream bandwidth.

In addition, the IEEE 802.3 Ethernet media access control (MAC) layer is a full-duplex MAC. It is desirable that an EPOC PHY be compatible with the full-duplex Ethernet MAC.

Accordingly, there is a need for efficient schemes for implementing full-duplex communications in an EPOC network or similar coaxial network.

### BRIEF DESCRIPTION OF THE DRAWINGS

The present embodiments are illustrated by way of example and are not intended to be limited by the figures of the accompanying drawings.

FIG. 1 is a block diagram of a coaxial network in accordance with some embodiments.

FIG. 2 illustrates timing of upstream and downstream transmissions as measured at a coax line terminal in accordance with some embodiments.

FIG. 3 is a block diagram of a coax line terminal coupled to a coax network unit in accordance with some embodiments.

FIG. 4 illustrates timing of a signal for controlling time-division duplexing in a coax line terminal in accordance with some embodiments.

FIG. 5 shows an example of a MAC sublayer as defined in clause 77 of IEEE Std. 802.3av-2009.

FIG. 6 is a flowchart illustrating a method of operating a coax line terminal in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

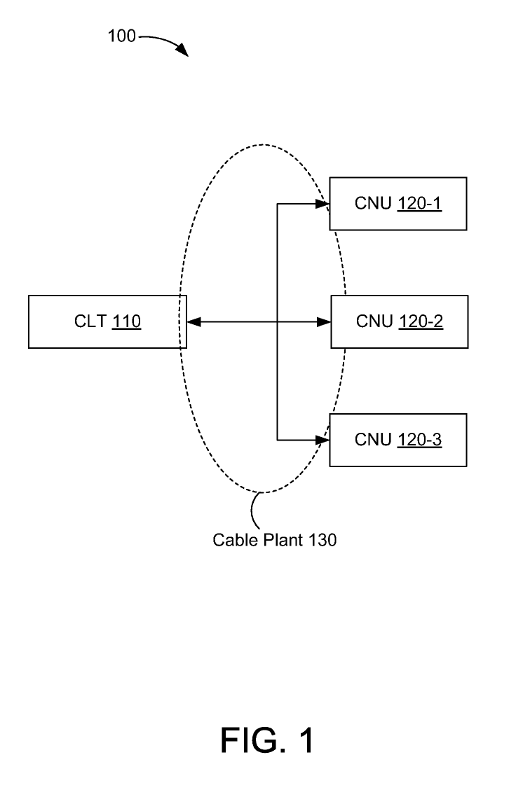

FIG. 1 is a block diagram of a coax network 100 (e.g., an EPON network) in accordance with some embodiments. The network 100 includes a coax line terminal (CLT) 110 coupled to a plurality of coax network units (CNUs) 120-1, 120-2, and 120-3 via coax links. A respective coax link may be a passive coax cable, or alternately may include one or more amplifiers and/or equalizers. The coax links compose a cable plant 130. In some embodiments, the CLT 110 is located at the premises of the cable plant operator and the CNUs 120 are located at the premises of respective users. The coax links introduce propagation delays between the CLT 110 and each CNU 120.

In some embodiments, the CLT 110 is part of an optical-coax unit (OCU) that is also coupled to an optical line terminal (OLT). The OCU functions as a coax media converter (CMC) that converts optical signals to electrical signals (and vice-versa) and may perform additional functions such as joint resource allocation between optical and coax links.

The CLT 110 transmits downstream signals to the CNUs 120-1, 120-2, and 120-3 and receives upstream signals from the CNUs 120-1, 120-2, and 120-3. In some embodiments, each CNU 120 receives every packet transmitted by the CLT 110 and discards packets that are not addressed to it. The CNUs 120-1, 120-2, and 120-3 transmit upstream signals at scheduled times specified by the CLT 110. For example, the CLT 110 transmits control messages (e.g., GATE messages) to the CNUs 120-1, 120-2, and 120-3 specifying respective future times at which respective CNUs 120 may transmit upstream signals.

In some embodiments, the network 100 uses time-division duplexing (TDD): the same frequency band is used for both upstream transmissions from the CNUs 120 to the CLT 110 and downstream transmissions from the CLT 110 to the CNUs 120, and the upstream and downstream transmissions are duplexed in time. A first time unit is allocated for upstream transmissions and a second time unit is allocated for downstream transmissions. These time units are also referred to as time periods or time windows. For example, alternating time periods are respectively allocated for upstream and downstream transmissions. In some embodiments, the network 100 is operable in at least two modes; it uses TDD in a first mode and FDD in a second mode. The CLT 110 and CNUs 120 thus may be configurable to operate in either TDD or FDD modes.

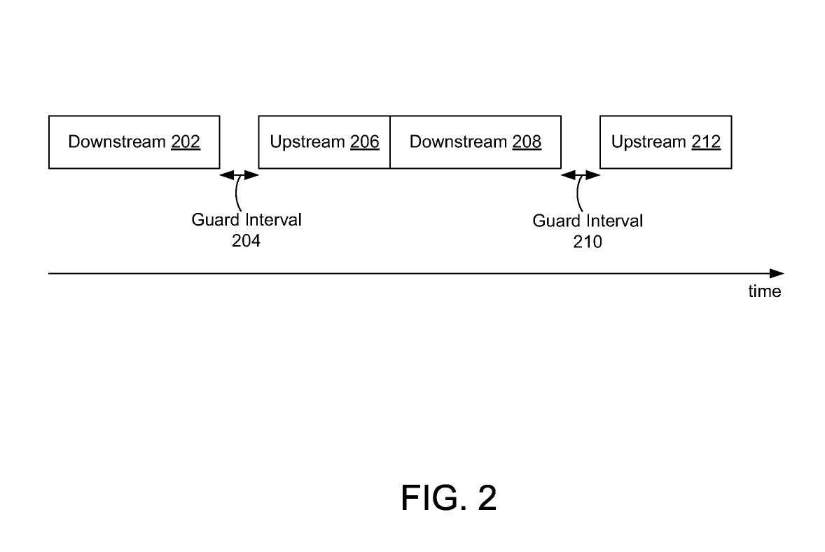

FIG. 2 illustrates timing of upstream and downstream time windows as measured at the CLT 110 in TDD mode in accordance with some embodiments. As shown in FIG. 2, alternating time periods are allocated for upstream and downstream transmissions. During a first time unit 202, the CLT 110 (FIG. 1) transmits signals downstream to the CNUs 120-1, 120-2, and 120-3. The first time unit 202 is followed by a guard interval 204, after which the CLT 110 receives upstream signals from one or more of the CNUs 120 during a second time unit 206. The guard interval 204 accounts for propagation time on the coaxial links and for switching time in the CLT 110 to switch from a transmit configuration to a receive configuration. The guard interval 204 thus ensures separate upstream and downstream time windows at the CNUs 120. The second time unit 206 is immediately followed by a third time unit 208 for downstream transmission, another guard interval 210, and a fourth time unit 212 for upstream transmission. Alternating downstream and upstream time windows continue in this manner, with successive downstream and upstream time windows being separated by guard intervals and the downstream time windows immediately following the upstream time windows, as shown in FIG. 2. The upstream and downstream transmissions during the time windows 202, 206, 208, and 212 use the same frequency band. The time allocated for upstream time windows (e.g., time units 206 and 212) may be different than the time allocated for downstream time windows (e.g., time units 202 and 208). FIG. 2 illustrates an example in which more time (and thus more bandwidth) is allocated to downstream time windows 202 and 208 than to upstream time windows 206 and 212.

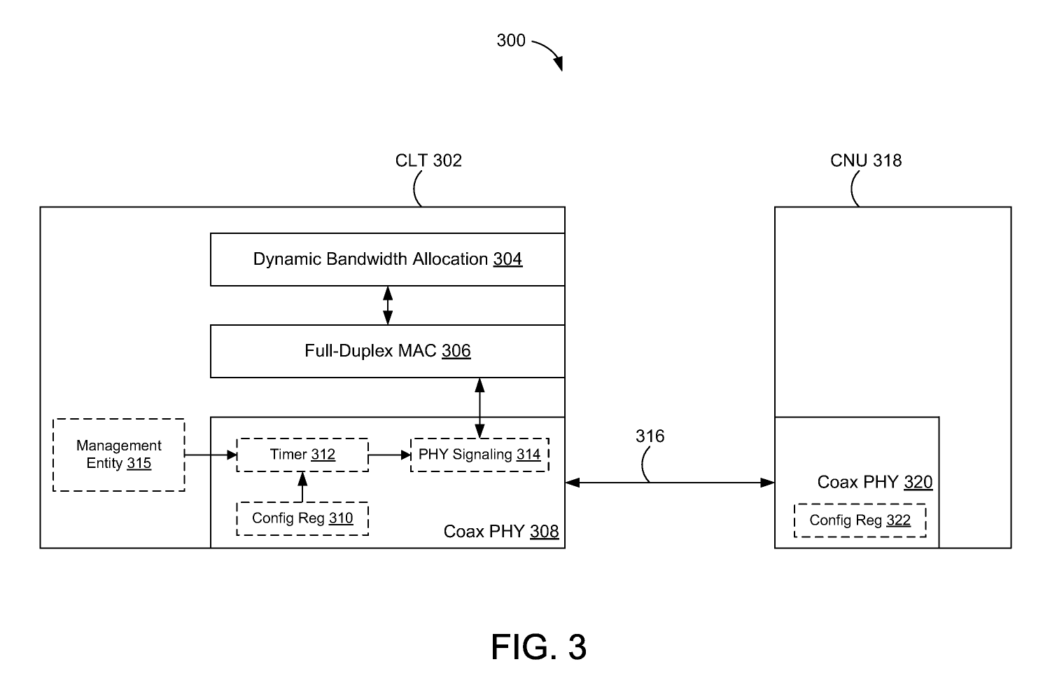

FIG. 3 is a block diagram of a system 300 in which a coax line terminal 302 is coupled to a CNU 318 by a coax link 316 in accordance with some embodiments. The CLT 302 is an example of a CLT 110 (FIG. 1) and the CNU 318 is an example of a CNU 120 (FIG. 1). The CLT 302 and CNU 318 can communicate via the coax link 316 using TDD. In some embodiments, the CLT 302 and CNU 318 communicate using TDD in a first mode and FDD in a second mode.

The CLT 302 includes an instance (i.e., an implementation) of a coax physical layer (PHY) 308 that transmits signals onto and receives signals from the coax link 316. Likewise, the CNU 318 includes an instance (i.e., an implementation) of a coax physical layer (PHY) 320 that transmits signals onto and receives signals from the coax link 316. (Instances of other network processing layers in the CNU 318 are not shown for simplicity.) In some embodiments, the PHYs 308 and 320 are orthogonal frequency-division multiplexing (OFDM) PHYs that transmit and receive OFDM symbols using TDD (e.g., as shown in FIG. 2). In some embodiments, the PHYs 308 are configurable to use TDD in a first mode and FDD in a second mode. For example, the PHY 308 in the CLT 302 includes a configuration register 310 that stores a value specifying whether the PHY 308 is configured in TDD mode or FDD mode. The PHY 320 in the CNU 318 includes a similar configuration register 322.

In the CLT 302, the coax PHY 308 is coupled to an instance (i.e., an implementation) of a full-duplex media access control (MAC) sublayer 306. The instance of the MAC sublayer 306 may be referred to as a media access controller. (For example, MAC sublayer 306 is a sublayer of Layer 2 of the OSI networking model.) The PHY 308 includes a physical layer signaling component 314 that provides an interface to the MAC sublayer 306. The PHY signaling component 314 provides control signals to the MAC sublayer 306 to enable to the MAC sublayer 306 to perform its transmit and receive functions. For example, the PHY signaling component 314 provides a carrier sense signal (e.g., the “carrierSense” signal as defined in Annex 4A of the IEEE 802.3 Ethernet standard) to the MAC sublayer 306 to indicate whether or not the PHY 308 is available for transmission. The PHY signaling component 314 also may provide a receive signal (e.g., the “receiveDataValid” signal as defined in Annex 4A of the IEEE 802.3 Ethernet standard) to indicate the presence of incoming data.

Carrier sense signals (e.g., carrierSense) traditionally are used in Carrier Sense Multiple Access (CSMA) communications protocols in which multiple devices may attempt to access a communications medium at the same time. In CSMA, a transmitter checks whether its corresponding receiver in a PHY is receiving data; if the receiver is receiving data (and the PHY is thus congested), the transmitter does not attempt to transmit. When asserted, the carrier sense signal indicates that the PHY is busy and that the associated MAC sublayer should not initiate transmission. The systems 300 (FIGS. 3) and 100 (FIG. 1) do not have a risk of multiple access at a given time. The CLT 302 thus can use the carrier sense signal for a different purpose: to specify the upstream and downstream transmission windows (e.g., upstream windows 206 and 212 and downstream windows 202 and 208, FIG. 2). A timer 312 in the PHY 308 generates the carrier sense signal, which is provided to the MAC sublayer 306 via the PHY signaling component 314. The carrier sense signal instructs the MAC sublayer 306 as to when it is allowed to transmit.

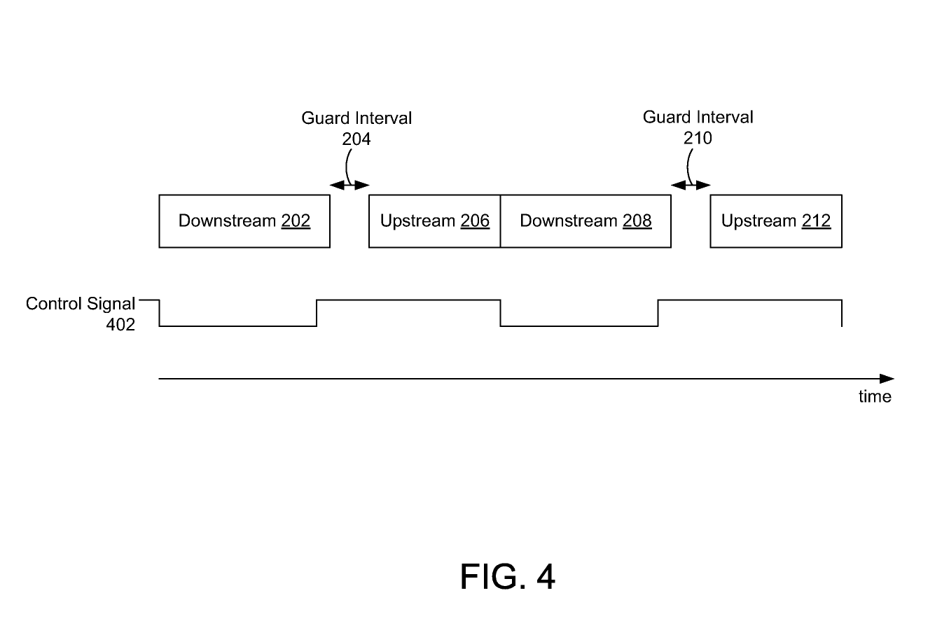

FIG. 4 illustrates timing of a control signal 402 that is an example of a carrier sense signal generated by the timer 312 (FIG. 3) in accordance with some embodiments. The control signal 402 controls time-division duplexing in the CLT 302. When the control signal is at a logic-low level and thus is de-asserted, the MAC sublayer306 is allowed to transmit data (e.g., to provide framed data to the PHY 308 for transmission onto the coax link 316). The downstream windows 202 and 208 (FIG. 2) thus begin when the control signal 402 transitions from a logic-high level to a logic-low level. Subsequent transition of the control signal 402 from the logic-low level to the logic-high level signals the MAC sublayer 306 to stop transmission. The downstream windows 202 and 208 thus end slightly after assertion of the control signal 402, to allow completion of transmission of the current symbol. The upstream windows 206 and 212 then begin after the guard intervals 204 and 210 expire. The upstream windows 206 and 212 end upon subsequent de-assertion of the control signal 402. While the control signal 402 has been described as being de-asserted at a logic-low level and asserted at a logic-high level, these polarities may be reversed.

The control signal 402 has been described as an example of a carrier sense signal. In some embodiments, however, the control signal 402 is a separate signal distinct from the carrier sense signal.

In embodiments in which the PHY 308 is configurable to operate in either TDD or FDD modes, the timer 312 is coupled to the configuration register 310. When the value in the configuration register 310 indicates that TDD mode has been selected, the timer 312 is enabled and generates the control signal 402 with the waveform illustrated in FIG. 4. When the value in the configuration register 310 indicates that FDD mode has been selected, the timer 312 is disabled and the control signal 402 is held constant such that it is de-asserted (e.g., at a logic-low level), thus allowing the MAC sublayer 306 to transmit frames regardless of whether or not the PHY 308 is receiving data.

To transmit frames in TDD mode, the MAC sublayer 306 (FIG. 3) receives data from its client (e.g., an instance of the next higher network processing layer or sublayer, which is not shown in FIG. 3 for simplicity) and builds a frame (e.g., an Ethernet frame) for the data. The MAC sublayer 306 prepends a preamble and a start frame delimiter to the data, pads the data payload as needed to ensure a minimum duration, prepends the source address (SA) and destination address (DA), adds a type/length field, and adds a frame check sequence (FCS) for error detection. The MAC sublayer 306 then begins frame transmission once the control signal 402 (e.g., carrierSense) is de-asserted (e.g., as shown in FIG. 4) and after inter-frame delay. Because the timer 312 (FIG. 3) generates the control signal 402, the timer 312 thus specifies when downstream transmission can occur by specifying when the MAC sublayer 306 can perform frame transmission.

When the PHY 308 detects that a frame has been received from the CNU 318 (e.g., during an upstream window 206 or 212, FIG. 2), the PHY 308 (e.g., PHY signaling component 314) asserts the receive signal (e.g., receiveDataValid) after PHY synchronization has been performed. The PHY 308 decodes the received data and provides the decoded data to the MAC sublayer 306. The MAC sublayer 306 discards the preamble and start frame delimiter, decapsulates the data, and checks the destination address to determine whether the data is intended for the CLT 302. The MAC sublayer 306 then checks the frame check sequence and provides the frame (minus the preamble and start frame delimiter to its client (again, not shown in FIG. 3 for simplicity).

For downstream reception of signals at the CNU 318, the CLT 302 provides TDD timing information (e.g., based on the control signal 402, FIG. 4, as generated by timer 312) to the CNU 318. The CLT 302 may provide the TDD timing information to the CNU 318 using physical layer signaling or upper-layer signaling. The PHY 320 in the CNU 318 uses the TDD timing information to receive non-continuous downstream signals from the CLT 302.

The CLT 302 includes a dynamic bandwidth allocation (DBA) system 304 coupled to the MAC sublayer 306. The DBA system 304, which is also referred to as a scheduler, sends control messages (e.g., GATE messages) to downstream CNUs (e.g., CNU 318) that specify when the downstream CNUs may transmit upstream. For example, a respective GATE message specifies a start time (“startTime”) and a length for an upstream transmission from the CNU 318. The start time and length are selected so that the upstream transmission falls entirely within an upstream time window (e.g., upstream time window 206 or 212, FIG. 2). The control messages (e.g., GATE messages) are transmitted from the CLT 302 to downstream CNUs during downstream time windows (e.g., downstream time windows 202 and 208, FIG. 2). The control signal 402 thus is made available to the DBA system 304 to allow the DBA system 304 to transmit the control messages (e.g., GATE messages) during the downstream time windows.

In some embodiments, the CLT 302 includes a management entity 315, coupled to the timer 312, that can dynamically adjust the timer 312 and thereby adjust the durations of upstream and downstream time windows as specified by the control signal 402 (FIG. 4). Upstream and downstream time windows may be adjusted to adjust transmission latencies and to adjust the amount of overhead resulting from guard intervals 204, as well as to adjust the division of bandwidth between upstream and downstream transmissions.

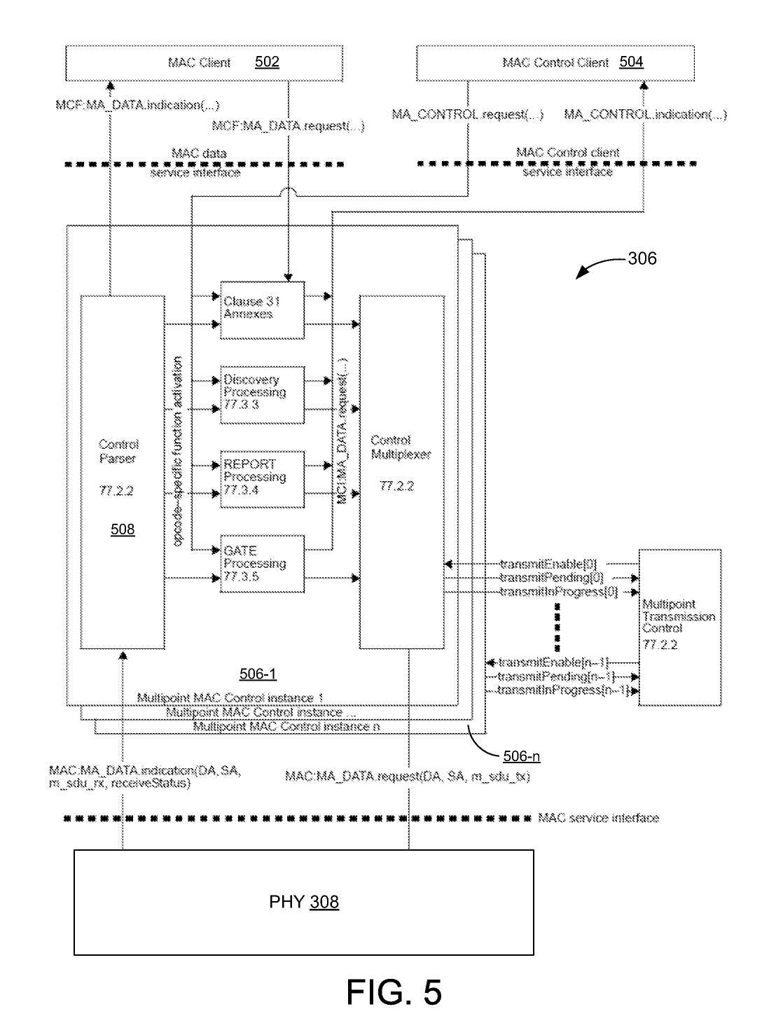

FIG. 5 shows an example of the MAC sublayer 306 as defined in section 77 of IEEE Std. 802.3av-2009. In this example, the MAC sublayer 306 is coupled to a MAC client 502 and a MAC control client 504, as well as to the PHY 308. The MAC sublayer 306 includes a plurality of multipoint MAC control instances 506-1 through 506-n, each corresponding to a respective CNU (e.g., CNU 318) coupled to the CLT 302 (FIG. 3). The PHY 308 provides the control signal 402 (FIG. 4) to the MAC sublayer 306 (e.g., to the control parsers 508 in the respective control instances 506-1 through 506-n). When asserted, the control signal 402 disables transmission by the control instances 506-1 through 506-n, thus assuring that data is only transmitted during downstream time windows.

In different embodiments, different components of the CLT 302 as shown in FIGS. 3 and 5 may be implemented in a single integrated circuit or in different integrated circuits.

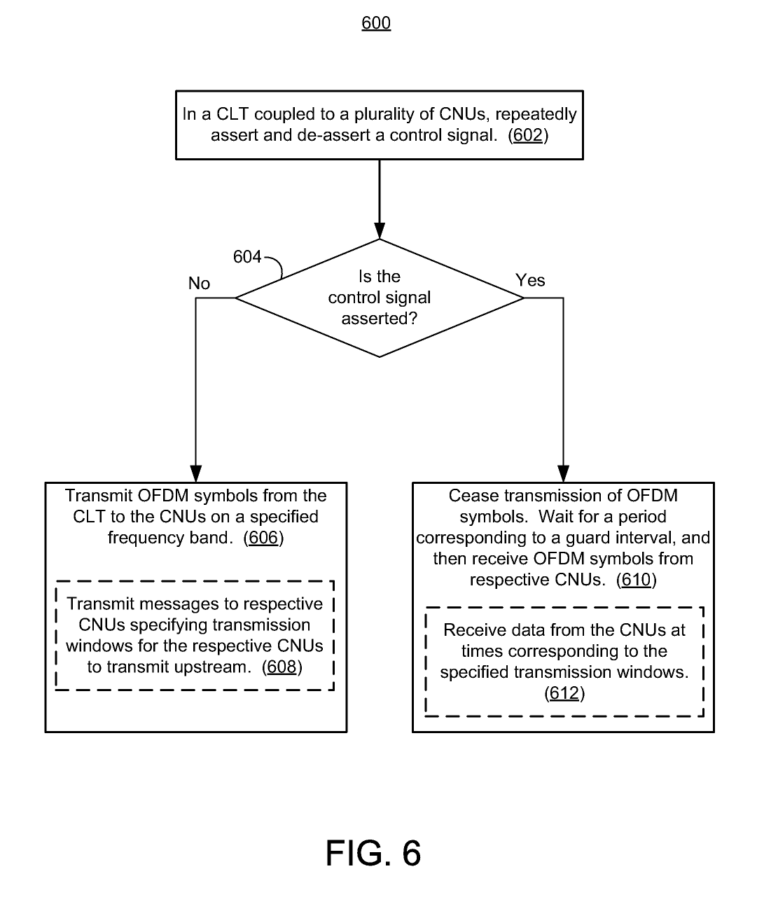

FIG. 6 is a flowchart illustrating a method 600 of operating a coax line terminal (e.g., CLT 110, FIG. 1, and/or CLT 302, FIG. 3) in accordance with some embodiments. The CLT of the method 600 is coupled to a plurality of CNUs (e.g., CNUs 120-1 through 120-3, FIG. 1, including for example CNU 318, FIG. 3) via a cable plant (e.g., cable plant 130, FIG. 1).

In the method 600, a control signal (e.g., control signal 402, FIG. 4, as generated by timer 312, FIG. 3) is repeatedly asserted and de-asserted (602). In some embodiments, the control signal is a carrier sense signal (e.g., carrierSense). When the control signal is de-asserted (604-No), data (e.g., OFDM symbols) are transmitted (606) from the CLT to the CNUs on a specified frequency band. In some embodiments, control messages (e.g., GATE messages) are transmitted (608) from the CLT to respective CNUs specifying transmission windows in which respective CNUs may transmit data upstream to the CLT.

When the control signal is asserted (604-Yes), transmission of OFDM symbols ceases (610). For example, transmission of the current symbol is completed, after which transmission ceases. After waiting for a period corresponding to a guard interval (e.g., guard interval 204, FIG. 2), data (e.g., OFDM symbols) are received from respective CNUs. In some embodiments, symbols (and thus data) from CNUs are received (612) at times corresponding to transmission windows specified in the control messages of operation 608.

The method 600 thus allows for communication between a CLT and CNUs using TDD in an EPOC network or similar coaxial network. While the method 600 includes a number of operations that appear to occur in a specific order, it should be apparent that the method 600 can include more or fewer operations, which can be executed serially or in parallel. An order of two or more operations may be changed and two or more operations may be combined into a single operation.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of operating a coax line terminal coupled to a plurality of coax network units by a coax plant, the method comprising:
repeatedly asserting and de-asserting a control signal;
when the control signal is de-asserted, transmitting data to the plurality of coax network units, wherein the data are transmitted on a specified frequency band; and
when the control signal is asserted, ceasing transmission of data to the plurality of coax network units and receiving data from respective coax network units of the plurality of coax network units, wherein the data are received on the specified frequency band.

2. The method of claim 1, further comprising:
when the control signal is de-asserted, transmitting a message addressed to a respective coax network unit of the plurality of coax network units, wherein the message specifies a subsequent transmission window for the respective coax network unit to transmit data upstream and the message is transmitted using the specified frequency band.

3. The method of claim 2, further comprising receiving the data from the respective coax network unit at the coax line terminal at a time corresponding to the subsequent transmission window.

4. The method of claim 1, wherein the control signal is a carrier sense signal.

5. The method of claim 1, wherein repeatedly asserting and de-asserting the control signal comprises generating the control signal using a timer.

6. The method of claim 5, further comprising dynamically adjusting the timing of the control signal.

7. The method of claim 1, further comprising:
after ceasing the transmission of data to the plurality of coax network units in response to the control signal being asserted, waiting for a period corresponding to a guard interval before receiving data from a respective coax network unit.

8. The method of claim 1, wherein:
transmitting data to the plurality of coax network units comprising transmitting orthogonal frequency-division multiplexing (OFDM) symbols to the plurality of coax network units; and
receiving data from respective coax network units comprises receiving OFDM symbols from respective coax network units.

9. The method of claim 8, wherein ceasing transmission of data when the control signal is asserted comprises finishing transmission of a symbol.

10. The method of claim 1, wherein:
the coax line terminal comprises a coax physical layer (PHY) instance and a full-duplex media access controller coupled to the PHY instance; and
the method further comprises providing the control signal from the PHY instance to the media access controller to control transmission of data from the coax line terminal to the coax network unit.

11. The method of claim 10, wherein the PHY instance comprises a timer that generates the control signal.

12. The method of claim 10, wherein:
the media access controller comprises a plurality of multipoint MAC control instances corresponding to respective coax network units; and
the control signal prevents the plurality of multipoint MAC control instances from initiating data transmission when asserted.

13. The method of claim 1, wherein the control signal is repeatedly asserted and de-asserted in a first mode of operation, the method further comprising:
in a second mode of operation, leaving the control signal de-asserted; and
in the second mode of operation, transmitting data to the plurality of coax network units on a transmit frequency band and receiving data from respective coax network units on a receive frequency band distinct from the transmit frequency band.

14. The method of claim 13, wherein the coax line terminal comprises a configuration register, the method further comprising:
storing a first value in the configuration register to enable assertion of the control signal in the first mode; and
storing a second value in the configuration register to disable assertion of the control signal in the second mode.

15. A coax line terminal, comprising:
a full-duplex media access controller;
a coax PHY instance to transmit and receive data on a specified frequency band; and
a timer, associated with the coax PHY instance, to generate a control signal to enable transmission and reception of data on the specified frequency band in an alternating manner.

16. The coax line terminal of claim 15, wherein the media access controller is Ethernet compatible.

17. The coax line terminal of claim 15, wherein:
the coax PHY instance is to transmit and receive ODFM symbols on the specified frequency band; and
the control signal is to enable transmission and reception of the OFDM symbols on the specified frequency band.

18. The coax line terminal of claim 15, wherein the coax PHY instance comprises a signaling component to provide the control signal to the media access controller.

19. The coax line terminal of claim 18, wherein the media access controller is to initiate data transmission in response to de-assertion of the control signal and is to cease data transmission in response to assertion of the control signal.

20. The coax line terminal of claim 18, wherein:
the media access controller comprises a plurality of multipoint MAC control instances corresponding to respective coax network units to be coupled to the coax line terminal; and
data transmission by the multipoint MAC control instances is to be disabled when the control signal is asserted.

21. The coax line terminal of claim 15, further comprising a scheduler to initiate transmission of control messages to coax network units to be coupled to the coax line terminal, wherein the control messages are transmitted on the specified frequency band and a respective control message specifies an upstream transmission window for a respective coax network unit.

22. The coax line terminal of claim 21, wherein:
the scheduler is to initiate transmission of the control messages when the control signal is de-asserted; and
the upstream transmission window for the respective coax network unit corresponds to a time period when the control signal is asserted.

23. The coax line terminal of claim 15, further comprising a configuration register, associated with the coax PHY instance, to store a value specifying a mode, wherein:
the coax PHY is to transmit and receive data on the specified frequency band when the configuration register stores a first value corresponding to a first mode; and
the coax PHY is to transmit data on a transmit frequency band and receive data on a receive frequency band distinct from the transmit frequency band when the configuration register stores a second value corresponding to a second mode.

24. A coax line terminal, comprising:
means for transmitting and receiving data on a specified frequency band; and
means for generating a control signal to alternate the transmitting and receiving on the specified frequency band.
